(19) United States
(12) Patent Application Publication
(10) Pub. No.: US 2025/0285132 A1
(43) Pub. Date: Sep. 11, 2025

(54) SYSTEM AND METHOD FOR DEMAND-BASED OPTIMIZATION OF AIRLINE TICKET PRICING

(71) Applicant: IBS Software FZ-LLC, Dubai (AE)

(72) Inventors: Jeswin Varghese, Ernakulam (IN); Sharath Nataraj, Ernakulam (IN); Kelwin Kuriachan, Trivandrum (IN); Vineesh Vijayan, Alappuzha (IN); Kanu Aravindakshan, Ernakulam (IN)

(21) Appl. No.: 18/599,272

(22) Filed: Mar. 8, 2024

(51) Int. Cl. G06Q 30/0201

(52) U.S. Cl. CPC G06Q 30/0206

(57) ABSTRACT

The present subject matter relates to a system (100) and a method (400) for demand-based optimization of airline ticket pricing. The disclosed system (100) includes is a user interface (101) that facilitates the input of flight information, subsequently processed by an integrated memory (203) and processor (201). The machine learning-driven price optimization module (204) involves fetching price range and contextual information, extracting features, and further utilizing a classification model (205) for identifying demand cluster probabilities, and calculating a demand score. The system (100) further refines this demand score to account for market fluctuations. Notably, it employs advanced techniques like density-based clustering for demand segmentation and ML explainability through the Airline Experience Quotient (AEQ). This ensures transparency and enhances the user experience. Additionally, the system's capability extends to efficient model deployment, leveraging MLOps, and presenting the optimal ticket price to users for informed decision-making.

### CROSS-REFERENCE TO RELATED APPLICATIONS AND PRIORITY

The present application does not claim priority from any other patent application.

### FIELD OF INVENTION

The present subject matter described herein, in general, relates to aviation industry. More specifically, the present invention relates to automatic airline pricing mechanism. More particularly, the present invention relates to a machine learning-driven demand-based optimization of airline ticket pricing.

### BACKGROUND OF THE INVENTION

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

This section is intended to introduce the reader to various aspects of art, which may be related to various aspects of the present disclosure that are described or claimed below. This discussion is believed to be helpful in providing the reader with background information to facilitate a better understanding of the various aspects of the present disclosure. Accordingly, it should be understood that these statements in this background section are to be read in this light, and not as admissions of prior art. Similarly, a problem mentioned in the background section or associated with the subject matter of the background section should not be assumed to have been previously recognized in the prior art. The subject matter in the background section merely represents different approaches, which in and of themselves may also correspond to implementations of the claimed technology.

The existing conventional systems for airline ticket pricing have been primarily based on static pricing models that rely on predetermined pricing strategies, historical data analysis, and basic market segmentation. These systems often lack the agility and adaptability required to respond dynamically to fluctuating demand patterns, seasonal variations, or real-time market conditions. Consequently, airlines frequently face challenges in optimizing revenue, maximizing seat occupancy, and offering competitive pricing to attract customers.

One of the significant drawbacks of these conventional systems is their limited ability to factor in real-time demand dynamics. Traditional systems often employ fixed pricing tiers or fare classes that do not adjust promptly to changes in demand or supply. As a result, airlines may either set prices too high, discouraging potential passengers, or too low, thereby missing out on potential revenue. This rigidity in pricing often leads to suboptimal outcomes, with seats remaining unsold or sold at rates that do not reflect their true value.

Furthermore, the lack of advanced machine learning capabilities in conventional systems hampers their ability to adapt and evolve in response to changing market dynamics. These systems often struggle to incorporate complex data sets, perform sophisticated data analysis, or generate actionable insights in real-time. The absence of machine learning-driven predictive modeling and optimization techniques further limits the effectiveness of conventional systems in maximizing revenue and enhancing the overall customer experience.

The airline industry has long utilized dynamic pricing strategies to optimize revenue, adapting ticket prices based on a myriad of factors such as the day of the flight, time of the flight, and demand patterns. As a flight's departure date nears, it's not uncommon to witness fluctuations in ticket prices, a reflection of the airlines' effort to maximize seat occupancy and, consequently, to increase revenue. Central to this dynamic pricing strategy is the concept of “fare classes,” where seats are virtually grouped and assigned specific fare range from low fare to high fare. These fare classes serve as the foundation upon which airlines determine ticket pricing. When the goal is to fill seats rapidly, airlines might offer tickets from fare classes with lower fares, adjusting as demand and time progress. The management of these fare class openings and closures, and the consequent price adjustments, is typically managed by specialized Revenue Management Software.

However, while this dynamic pricing mechanism offers advantages in revenue optimization, it is not without its challenges. One of the primary drawbacks lies in the deterministic nature of fare adjustments. As airlines transition from one fare class to another, the price difference is noticeable rather than a smooth continuum. For instance, when ticket prices abruptly transition from a lower to a higher fare class, potential passengers whose budget lies between these two fare points may be deterred from making a purchase, resulting in lost revenue opportunities for the airline.

Addressing this discontinuity in fare variations is non-trivial. Traditional software solutions, reliant on rule-based programming, face significant limitations in managing such intricacies. These algorithms may not effectively capture the intricate relationships between various demand drivers, such as route popularity, time of booking, competitor pricing, and customer preferences. As a consequence, the pricing strategies generated by these conventional systems may not align with market demand, leading to missed revenue opportunities and decreased profitability for airlines.

Further, traditional solutions for dynamic price calculation are largely depending on significant number of rules implemented for catering demand-based fare calculation requirement, which is difficult to manage or use properly. Further, identifying insights from the complex calculations along with non-airline domain jargons in the programming leads to lacking the information on demand-based airline experience to the stakeholders for making required business decisions.

Additionally, in the rapidly evolving market scenario, adaptation to new route or segment of passengers is difficult due to dependency on the large pool of rules for update.

Thus, there is a need for an innovative approach to develop a mechanism that facilitates smoother fare transitions within the existing dynamic pricing infrastructure, thereby creating a more passenger-friendly airline pricing system.

### SUMMARY OF THE INVENTION

Before the present system and device and its components are summarized, it is to be understood that this disclosure is not limited to the system and its arrangement as described, as there can be multiple possible embodiments which are not expressly illustrated in the present disclosure. The present disclosure overcomes one or more shortcomings of the prior art and provides additional advantages discussed throughout the present disclosure. Additional features and advantages are realized through the techniques of the present disclosure. It is also to be understood that the terminology used in the description is for the purpose of describing the versions or embodiments only and is not intended to limit the scope of the present application. This summary is not intended to identify essential features of the claimed subject matter nor is it intended for use in detecting or limiting the scope of the claimed subject matter.

In one embodiment of the present disclosure, a system for demand-based optimization of airline ticket pricing is disclosed. The system includes a memory and a processor coupled with the memory. The processor may be configured to execute programmed instructions stored in the memory. The system includes a user interface (UI) for receiving one or more user inputs. The one or more user inputs may comprise one of flight information, passenger information or a combination thereof. Further, the system includes a price optimization module for calculating an optimized price of the airline ticket based on demand, using a machine learning (ML) system which is executed by the processor. The optimization module further retrieves a price range and contextual information associated the one or more user inputs. By extracting one or more relevant features from the contextual information, the system employs a classification model to assess the likelihood of demand in terms of probability score across various clusters. Further, by identifying a demand cluster from one or more demand clusters corresponding to the contextual information, the optimization module calculates a demand score. This demand score is calculated by summation of element wise multiplication of probabilities and scaled cluster densities of each cluster. Further, the optimization module is configured to calculate the optimized price of the airline ticket utilizing this demand score with the price range. In an embodiment, the price range consisting of both a minimum price and a maximum price. Furthermore, the system enables the optimization module to present the calculated optimized airline ticket price to the user for consideration.

In another embodiment, the system may utilize a density-based clustering algorithm to segment and label the one or more demand clusters. Further, the classification model may be trained at the flight route level based on these labelled clusters. Further, the optimized price may be calculated using a specific formula. Additionally, the demand score might be adjusted to reflect deviations in the current market, ensuring accuracy. Further, for feature selection, performed by the price optimization module, may involve using statistical techniques like Pearson's correlation or regression analysis to evaluate relationships between various attributes and volume of bookings. In one embodiment, the price optimization module may be configured to perform feature selection from the one or more features of a historical data having significant impact on successful bookings. In another embodiment of the present disclosure, the price optimization module is configured to utilize a collective approach for identifying relevant features based on combination of statistical techniques with aggregating analysis from a set of machine learning regression models like XGBoost, Random Forest, CatBoost regressors or a combination thereof. The underlying machine learning system may encompass techniques such as reinforcement learning, or self-learning combined with Thompson Sampling to maximize revenue for airline provider. Ensuring revenue growth through demand-based optimization of airline ticket pricing is a cornerstone feature of the system. The system's user interface may utilize ML explainability technique to present insights on an AEQ (Airline Experience Quotient) demand scoring in a user-friendly jargon-free explanation of the ML system's calculation of demand-based optimized airline ticket pricing. Lastly, the system may support MLOps based automated cluster configuration, model training and efficient model deployment.

In another embodiment of the present disclosure, a method for demand-based optimization of airline ticket pricing is disclosed. The method is a comprehensive approach that involves several key stages. The method may comprise a step for collecting data using a data collection module. In one embodiment, the method may interact with users through a user interface, for gathering one or more user inputs.

The one or more user input may comprise flight information, passenger information as inputs. Subsequently, the method may retrieve both a price range and relevant contextual data tied to the provided user inputs. Further, by receiving contextual information and utilizing advanced machine learning techniques, the method may dynamically calculate the optimal ticket price within the price range. Furthermore, the method delves into the contextual data for extracting pertinent features that are then fed into a classification model. Further the classification model may predict probability scores to each cluster from various demand clusters, aiding in pinpointing the most relevant demand cluster that aligns with the flight's and passenger specifics. Further for refining the pricing strategy, a demand score may be computed by integrating probabilities with the scaled cluster densities of the identified clusters. This cumulative score informs the final ticket price calculation, ensuring it resonates with both the flight's context and prevailing demand dynamics. Ultimately, this meticulously derived price is showcased to users, offering them a transparent and optimized fare option for their consideration.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF DRAWINGS

The detailed description is described with reference to the accompanying figures. In the figures, the left-most digit(s) of a reference number identifies the figure in which the reference number first appears. The same numbers are used throughout the drawings to refer like features and components.

FIG. 1 illustrates a block diagram describing a system (100) for demand-based optimization of airline ticket pricing, in accordance with an embodiment of a present subject matter.

FIG. 2 illustrates a diagram (200) showing an overview of a server (103) for demand-based optimization of airline ticket pricing, in accordance with an embodiment of a present subject matter.

FIG. 3 illustrates an exemplary flow diagram (300) describing the system (100) for demand-based optimization of airline ticket pricing, in accordance with an embodiment of a present subject matter.

FIG. 4 illustrates a flowchart describing a method (400) for demand-based optimization of airline ticket pricing, in accordance with an embodiment of the present subject matter.

### DETAILED DESCRIPTION OF THE INVENTION

Reference throughout the specification to “various embodiments,” “some embodiments,” “one embodiment,” or “an embodiment” means that a particular feature, structure, or characteristic described in connection with the embodiment is included in at least one embodiment. Thus, appearances of the phrases “in various embodiments,” “in some embodiments,” “in one embodiment,” or “in an embodiment” in places throughout the specification are not necessarily all referring to the same embodiment. Furthermore, the features, structures or characteristics may be combined in any suitable manner in one or more embodiments.

The words “comprising,” “having,” “containing,” and “including,” and other forms thereof, are intended to be equivalent in meaning and be open ended in that an item or items following any one of these words is not meant to be an exhaustive listing of such item or items or meant to be limited to only the listed item or items. It must also be noted that, the singular forms “a,” “an,” and “the” include plural references unless the context clearly dictates otherwise. Although any methods similar or equivalent to those described herein can be used in the practice or testing of embodiments of the present disclosure, the exemplary methods are described. The disclosed embodiments are merely exemplary of the disclosure, which may be embodied in various forms.

Conventional systems typically rely on static pricing models, predetermined fare classes, and simplistic algorithms that do not dynamically adapt to changing demand conditions. These algorithms may not effectively capture the intricate relationships between various demand drivers, such as route popularity, time of booking, competitor pricing, and customer preferences. As a consequence, the pricing strategies generated by these systems may not align with market demand, leading to missed revenue opportunities and decreased profitability for airlines.

Additionally, conventional systems may struggle to incorporate advanced machine learning (ML) techniques namely reinforcement learning effectively. Further, in the realm of operation pipeline, the seamless integration, deployment, and management of machine learning models in conventional systems may be suboptimal, leading to inefficiencies in real-time pricing adjustments and overall system performance.

Furthermore, one of the key limitations of traditional systems is their inability to provide a smooth and continuous variation in ticket prices based on demand. These systems often operate with predefined fare classes, resulting in abrupt price changes when transitioning between classes. This lack of smoothness can turn away potential passengers whose budget falls between the predefined fare classes, leading to missed revenue opportunities for airlines. This lack of adaptability is exacerbated by the absence of advanced ML algorithms, preventing the system from effectively analysing contextual factors, historical data, or adjusting in real-time to current market conditions. Moreover, the absence of machine learning-driven predictive modeling and optimization techniques further limits the effectiveness of conventional systems in maximizing revenue and enhancing the overall customer experience.

In the light of the above-mentioned limitations, a disclosed system represents a significant advancement in airline ticket pricing optimization. By leveraging advanced machine learning techniques, real-time data analysis, and dynamic pricing models, this system addresses many of the limitations inherent in conventional systems. It offers a more dynamic, adaptive, and data-driven approach to pricing optimization, enabling airlines to respond effectively to market fluctuations, maximize revenue, and deliver a superior customer experience.

Thus, the disclosed system, incorporating machine learning, reinforcement learning, and MLOps, addresses these drawbacks by introducing advanced algorithms for demand-based optimization, adaptive contextual understanding, and efficient data analysis, ultimately revolutionizing the airline ticket pricing paradigm.

In one non-limiting embodiment, a system for demand-based optimizing of airline ticket pricing is disclosed. The system employs a dynamic pricing model that calculates optimal ticket prices based on real-time demand, ensuring a more responsive and adaptive strategy. The use of a density-based clustering algorithm for demand segmentation, training the classification model at the flight route level, and incorporating features like the actual load factor in the demand score fine-tuning process are all measures designed to overcome the deficiencies of conventional systems.

Furthermore, the system's ability to perform feature selection from historical data, utilizing advanced statistical techniques and a collective approach involving statistical techniques with machine learning regression models like XGBoost and Random Forest, enables it to identify and leverage relevant features crucial for successful bookings. The integration of ML explainability through an insight on Airline Experience Quotient (AEQ) ensures transparency in presenting optimized prices to users and business stakeholders, addressing the lack of clarity often associated with conventional pricing models.

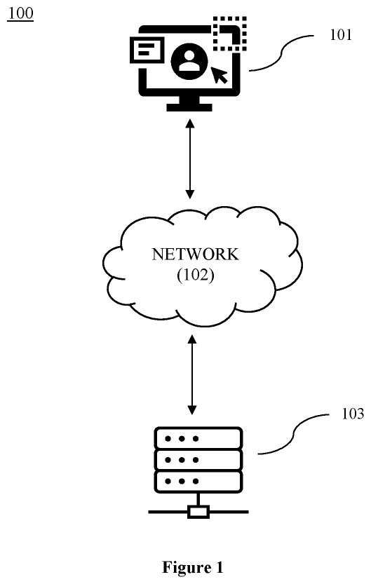

Now referring to FIG. 1, a block diagram describing a system (100) for demand-based optimization of airline ticket pricing, is illustrated in accordance with an embodiment of a present subject matter. The system (100) may include a user interface (UI) (101) interacting with an airline system server (103) via a network (102). In one embodiment, the user interface (101) may serve as the gateway for users to interact with the system (100), initiating requests and receiving outputs. These inputs are then processed by a robust combination of memory and processor components, where the system's core functionalities reside. Further, considering that the system (100) is implemented on a server (103), it may be understood that the system (100) may be accessed via a variety of computing systems. The computing system may correspond to an interface which enables the user to interact with the system (100). The computing system may comprise one selected from a group consisting of a cell phone, personal digital assistant (PDA), laptop computer, stationary personal computer, IPTV remote control, web tablet, laptop computer, pocket PC, a television set capable of receiving IP based video services and mobile IP device. In an embodiment, the system (100) consisting of sever (103) may be configured to receive user data from one or more users, via the user interface (101) in a computing system.

In yet another embodiment, the user interface (101) and the server (103) may communicate with each other via the network (102). In one implementation, the network (102) may be a wireless network, a wired network, or a combination thereof. The network (102) can be implemented as one of the different types of networks, such as intranet, local area network (LAN), wide area network (WAN), the internet, and the like. The network (102) may either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further, the network (103) may include a variety of network devices, including routers, bridges, servers, computing devices, storage devices, and the like.

In another embodiment, the network (102) may include any one of the following: a cable network, the wireless network, a telephone network (e.g., Analog, Digital, POTS, PSTN, ISDN, xDSL), a cellular communication network, a mobile telephone network (e.g., CDMA, GSM, NDAC, TDMA, E-TDMA, NAMPS, WCDMA, CDMA-2000, UMTS, 3G, 4G, 5G, 6G), a radio network, a television network, the Internet, the intranet, the local area network (LAN), the wide area network (WAN), an electronic positioning network, an X.25 network, an optical network (e.g., PON), a satellite network (e.g., VSAT), a packet-switched network, a circuit-switched network, a public network, a private network, and/or other wired or wireless communications network configured to carry data.

The system (100) can be implemented using hardware, software, or a combination of both, which includes using where suitable, one or more computer programs, mobile applications, or “apps” by deploying either on-premises over the corresponding computing terminals or virtually over cloud infrastructure. The system (100) may include various micro-services or groups of independent computer programs which can act independently in collaboration with other micro-services. The system (100) may also interact with a third-party or external computer system. Internally, the system (100) may be the central processor of all requests for transactions by the various actors or users of the system. A critical attribute of the system (100) is that it can concurrently and instantly complete an online transaction by a system user in collaboration with other systems. In a specific embodiment, the system (100) is implemented to provide a user, an optimized airline ticket price while searching for the flight ticket.

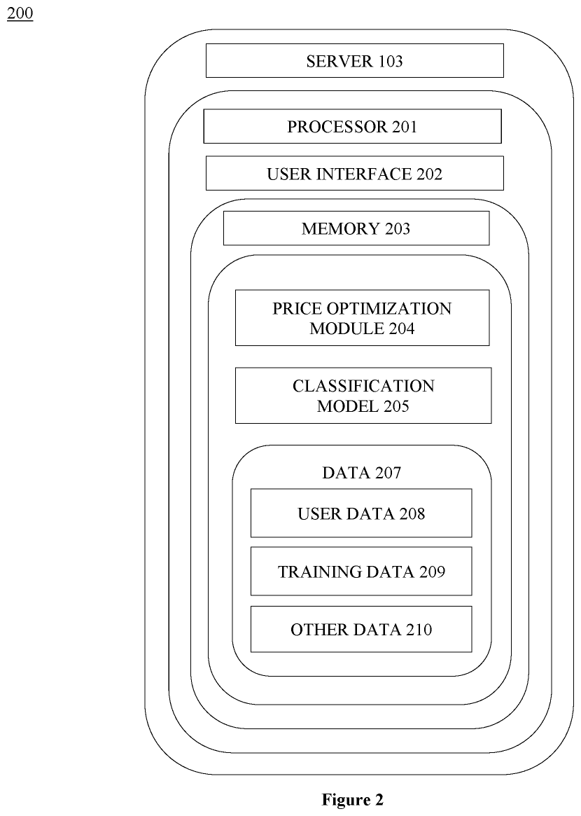

Now, referring to FIG. 2, a diagram (200) showing an overview of a server (103) for demand-based optimizing of airline ticket pricing, is illustrated in accordance with an embodiment of a present subject matter. The server (103) comprises a processor (201), an input/output (I/O) interface (202), and a memory (203). Further, the memory (203) may include a price optimization module (204), a classification model (205) and data (207). The data (207) may further comprise a user data (208), a training data (209), and other data (210). The processor (201) is coupled with the memory (203). The processor (201) is configured to execute programmed instructions stored in the memory (203). The processor, in one embodiment, may comprise a standard microprocessor, microcontroller, central processing unit (CPU), distributed or cloud processing unit, state machines, logic circuitries, and/or any devices that manipulate signals based on operational instructions and/or other processing logic that accommodates the requirements of the present invention.

Further, the I/O interface (202) is an interface to other components of the server (103) and the system (100). The I/O interface (202) may include a variety of software and hardware interfaces, for example, a web interface, a graphical user interface, and the like. The I/O interface (202) may allow the system (100) to interact with the user directly or through the computing devices. Further, the I/O interface (202) may enable the system (100) to communicate with other computing devices, such as web servers and external data servers (not shown). The I/O interface (202) can facilitate multiple communications within a wide variety of networks and protocol types, including wired networks, for example, LAN, cable, etc., and wireless networks, such as WLAN, cellular, or satellite. The I/O interface (202) may include one or more ports for connecting a number of devices to one another or to another server. In one embodiment, the I/O interface (202) allow the server (103) to be logically coupled to other computing system (101), some of which may be built in. Illustrative components include tablets, mobile phones, wireless device, etc. Further, the processor (201) can read data from various entities such as memory (203) or I/O interface (202). The processor's (201) primary functions encompass fetching price range and contextual information from the user input. The user input may correspond to information provided by a user during searching for a flight ticket on an airline portal or website.

The user input may comprise one of flight information, passenger information, or a combination thereof. In a specific embodiment, the flight information comprises flight number, origin, destination, time of flight etc. In another exemplary embodiment, the passenger information comprises number of passengers, adult child count etc. In yet another embodiment, the contextual information may comprise either the information provided in user input or may be dynamically derived from the information provided in the user input. In an exemplary embodiment, the contextual information comprises all the information related to a search query triggered by a passenger while searching for the flight ticket on the airline portal or website. Typically, this includes information on origin, destination, flight date, booking date, number of passengers, adult count, child count, flight number, time of flight, type of product offered and all such information pertaining to the passenger and the flight.

The memory (203) may include any computer-readable medium or computer program product known in the art including, for example, volatile memory, such as static random-access memory (SRAM) and dynamic random-access memory (DRAM), and/or non-volatile memory, such as read only memory (ROM), erasable programmable ROM, flash memories, hard disks, Solid State Disks (SSD), optical disks, magnetic tapes, memory cards, virtual memory and distributed cloud storage. The memory (203) may be removable, non-removable, or a combination thereof. The memory (203) may include routines, programs, objects, components, data structures, etc., which perform particular tasks or implement particular abstract data types. The memory (203) may include programs or coded instructions that supplement applications and functions of the system (100). In one embodiment, the memory (203), amongst other things, serves as a repository for storing data processed, received, and generated by one or more of the programs or the coded instructions. In yet another embodiment, the memory (203) may be managed under a federated structure that enables adaptability and responsiveness of the server (103). In one embodiment, the server (103) utilizes the processor (201) for executing the price optimization module (204) and the classification model (205) stored in the memory (203).

In another embodiment, the user interface (101) may serve as the gateway for users to interact with the system, initiating requests and receiving outputs. These inputs are then processed by a robust combination of memory and processor components, where the system's core functionalities reside. Further, the memory (203) may include a price optimization module (204). Further, a Machine Learning (ML) system embedded within the module is crafted through a sequence of steps that ensure optimal performance. Initially, the price optimization module (204) may fetch the pertinent price range and contextual data related to the provided flight information. Subsequently, the module dives deep into this data, extracting relevant features and employing them in a classification model (205). Further, the classification model (205), after analyzing the contextual data may assign a probability score to potential demand clusters.

In one embodiment, the price optimization module (205) may be configured to calculate an optimal price of the airline ticket based on demand, using a machine learning (ML) system carried out by the processor (201). Furthermore, the price optimization module (204) may be configured to retrieve a price range and contextual information corresponding to the flight information as per one or more user inputs. Further, the calculation of optimised price may include extraction of features from the contextual data. The price optimization module (204) also evaluates relationships between various attributes and volume of bookings for feature selection from historical data, employing statistical techniques such as Pearson's correlation or regression analysis.

Furthermore, the segmentation of these demand clusters may be achieved through a density-based clustering algorithm, ensuring that clusters are both distinct and representative of underlying demand patterns. As the classification model (205) operates at the flight route level, it offers granular insights, enabling more refined pricing strategies. Once clusters are identified, the system (100) may calculate a demand score, a pivotal metric derived from probabilities and cluster densities, to ascertain the most suitable ticket price.

In another embodiment, relevant features may be extracted from this contextual data, laying the foundation for subsequent analysis. Further, the classification model (205), may be trained specifically for various flight routes, predicts probability scores to different demand clusters based on the extracted features from the contextual information. This aids in categorizing the demand pattern accurately. By combining probabilities and scaled (normalized) cluster density weights, the system (100) may compute a comprehensive demand score, reflecting the current market demand for the flight route. In an exemplary embodiment of the present disclosure, the weight Wᵢ for each cluster is calculated as follows using the min-max scalar formula, such as Wᵢ=xᵢ−min (x)/max (x)−min (x), wherein Wᵢ denotes the weight at each cluster i, and xᵢ denotes density at each cluster i. An experiment details are provided in Table 1 as below:

| Cluster | Density | Normalized Weights |
|---|---|---|
| 0 | 295.6 | 1.0000 |
| 1 | 187.875 | 0.6307 |
| 2 | 160 | 0.5352 |
| 3 | 110.3 | 0.3648 |
| 4 | 63.125 | 0.2031 |
| 5 | 48.571429 | 0.1532 |
| 6 | 45.333333 | 0.1421 |
| 7 | 47.2 | 0.1485 |
| 8 | 30.134615 | 0.0900 |
| 9 | 3.875 | 0.0000 |

Based on examples given in Table 1, W₀=1, W₁=0.6307, W₂=0.5352 and so on. By utilizing these normalized weights of the clusters, demand score corresponding to each cluster can be calculated using demand score formula, such as Dᵢ=Wᵢ*Pᵢ, where Wᵢ is normalized cluster weight for cluster i and Pᵢ is normalized probability of cluster i. The normalization process may be applied to ensure that the weights are on a standardized scale. The purpose of assigning a constant weight at the cluster level is to emphasize the collective importance of the entire cluster in influencing the demand score. In this scenario, this multiplication of weight and probability reflects the importance of the entire cluster in determining the demand score. Thus, the demand score for a cluster is influenced collectively by the normalized probabilities and the constant weight assigned to that cluster.

Furthermore, considering the dynamic nature of the airline industry, the system introduces a finetuning mechanism for the demand score. This adjustment incorporates real-world deviations, ensuring that the system's pricing recommendations are attuned to current market conditions. An exemplary, but non-limiting formula for finetuning the demand score may be following:

New Demand Score=Demand Score*(Actual Load Factor/Expected Load Factor)

Utilizing the demand score and the predefined price range (comprising minimum and maximum prices), the system (100) calculates the most suitable ticket price resulting in overall increase in revenue for the airline provider. The formula ensures the price remains competitive yet reflective of the demand dynamics. In an exemplary embodiment, a non-limiting formula for calculating the optimized price may be following:

Optimized Price=(minimum price+(maximum price−minimum price)*demand score

In yet another embodiment, the classification model (205), with the help of processor (201), is configured to obtain a probability score for each demand cluster from one or more demand clusters, based on the extracted features from the contextual information Thus, the classification model may be used to obtain probability scores for demand clusters, identification of the relevant demand cluster, and the computation of a demand score. Furthermore, the demand score may be calculated by summation of element-wise multiplication of probabilities and scaled cluster densities of each cluster. Ultimately, the system (100) may utilize the initial price range and the calculated demand score to further calculate the optimized price of the airline ticket. Additionally, a collective approach is utilized to identify relevant features impacting successful bookings, by aggregating analysis from the statistical techniques with a set of machine learning regression models like XGBoost, Random Forest, CatBoost regressors, or their combinations.

Furthermore, the system (100) incorporates advanced machine learning techniques such as reinforcement learning or self-learning in combination with Thompson Sampling to ensure maximum revenue for airline providers. The overall goal is to increase revenue for airlines by employing demand-based optimization of ticket pricing. The system (100) also assesses available fare classes corresponding to user inputs and fetches the relevant price range accordingly. The UI enables users to conveniently search for flight tickets based on their inputs. In an exemplary embodiment, once an optimal price is computed using a given min-max, the price is passed through another self-optimization algorithm. This may work as follows. Once the optimal price is computed, for a particular min max range, for that price request the computed price is returned. But for the subsequent requests for the same airline experience and the same min max range, two additional prices will be chosen using Thompson sampling, one greater and one lesser than the computed optimal price, falling within the min max range, and the requests are responded to with these three prices in a round-robin fashion such that the three fares are equally distributed among the requests. At the end of the day, the revenue generated is computed for each of these fares by multiplying the fare with the number of tickets sold, and if the generated revenue is higher for the sampled fare that is higher than earlier optimal fare, then that means there is potential to increase the fare and vice versa. On the subsequent day, the fare that generated the maximum revenue for the particular airline experience value and min max range is chosen as the new optimal fare, and two more prices are chosen using Thompson sampling, one greater and one lesser than the new optimal price, and the cycle continues. This mechanism ensures that the airlines revenue is always maximized. This mechanism is referred as Reinforcement Learning or Self Learning. Here the system (100) on its own explores new fares using Thompson sampling and selects the fares that are most optimal.

In terms of explainability, the system (100) utilizes ML explainability technique to present insights on an AEQ (Airline Experience Quotient) demand scoring in a user-friendly jargon-free explanation of the ML system's calculation of demand-based optimized airline ticket pricing. Moreover, the system (100) supports MLOps-based efficient model deployment and training, ensuring operational efficiency in the integration of machine learning capabilities. The integration of ML explainability through the AEQ concept ensures transparency in presenting optimized prices to users and business stake holders, addressing the lack of clarity often associated with conventional pricing models. As an exemplary explanation, a key distinguishing feature of this solution lies in its utilization of ML explainability through the concept of AEQ (Airline Experience Quotient). At any given moment, the airline revenue manager gains insights into demand scoring through a concise decimal metric between 0 to 1 known as AEQ. This unique approach simplifies the intricate processes of ML into an easily understandable value. The pricing manager may desire a more in-depth understanding of AEQ. Therefore a dedicated dashboard is provided. This dashboard empowers the pricing manager to trace back the calculation of AEQ and its various components to granular levels. Throughout every stage of the ML process, transparency is maintained through the use of AEQ and the accompanying AEQ drill-down dashboard, ensuring a comprehensive understanding of the underlying mechanisms. Thus, the pricing manager doesn't need to know any ML aspects, and he/she can make sense of ML models through user-friendly and jargon-free explanations in dashboards. This user-centric approach enhances accessibility and facilitates informed decision-making within the pricing management domain.

Additionally, the system (100) supports MLOps based automated cluster configuration, model training and efficient model deployment. The system (100) may incorporate its fully automated MLOps pipeline, powered by state-of-the-art tools such as MLFlow, along with cutting-edge DevOps and ML Ops tools. The initiation of training for a new route is simplified through a user-friendly, one-click solution. By selecting the origin and destination routes, the system (100) may configure the necessary settings, and the training clusters, configured using Terraform and Ansible, are automatically launched. Once the routes are configured, the system (100) may retrieve the corresponding data from the repository, initiating the ML training process. The resulting models are saved in a versioned model repository, ensuring traceability and reproducibility. Subsequently, the model serving module becomes operational, providing AEQ predictions seamlessly through a RestAPI, supporting both bulk and single request modes. This comprehensive automation, from cluster configuration to model deployment, enhances the overall efficiency and agility of the pricing engine's MLOps pipeline.

In another embodiment, the data (207) stored in the memory (203) may include the user data (208) encompassing the details related to one or more users. Furthermore, the training data (209) used to train the system to dynamically optimise the ticket price may include flight data, ticket sales data, customer data, competitor data, load factor data. The exemplary embodiment of data may include information on flight schedules, routes, and availability of different fare classes, moreover, historical ticket sales data, including information on ticket prices, demand, and customer preferences, data on market conditions, seasonal trends, etc. Further, the other data (210) may include other relevant factors, ultimately leading to more efficient revenue management strategies and increased revenue for airlines.

Although the present disclosure is explained considering that the system (100) is implemented on a server, it may be understood that the system (100) may be implemented in a variety of computing systems, such as a laptop computer, a desktop computer, a notebook, a workstation, a virtual environment, a mainframe computer, a server, a network server, a cloud-based computing environment. It will be understood that the system (100) may be accessed by multiple users through one or more user devices. In one implementation, the system (100) may comprise the cloud-based computing environment in which the user may operate individual computing systems configured to execute remotely located applications. Examples of the user devices may include, but are not limited to, a portable computer, a personal digital assistant, a handheld device, and a workstation.

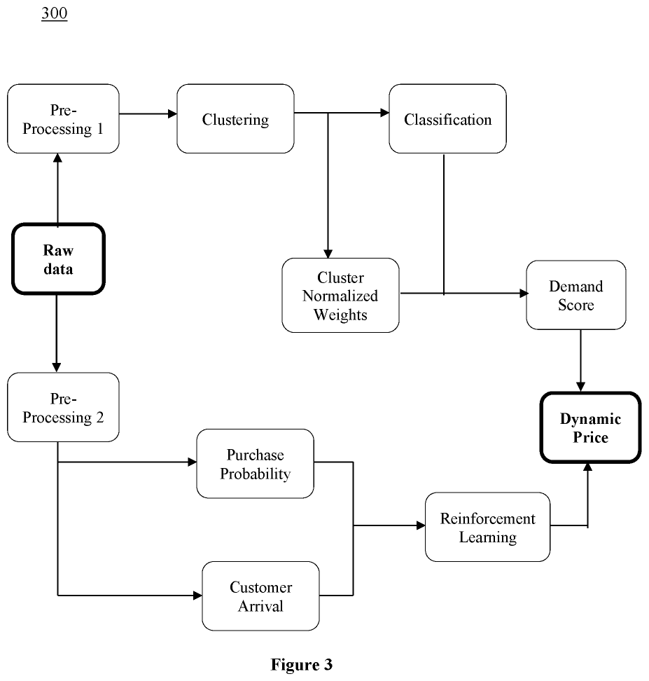

Now referring to FIG. 3, an exemplary flow diagram (300) describing the system (100) for demand-based optimizing of airline ticket pricing, is illustrated in accordance with an embodiment of the present subject matter. A raw data is collected including flight and booking specific details such as days to departure, flight timing, flying and booking dates, category of booking, and number of adults and children. Further, the data collected data may be pre-processed ensuring data quality, removing erroneous data, collecting competitor data, and creating new data fields derived from existing data. Further, data cleaning includes discarding or correcting negative or null values, excluding group bookings, and correcting discrepancies related to adult and child counts in the bookings. Data preprocessing involves creating new columns for day, month, year, and day of the week from booking date and flight date columns, extracting minimum stay from fare basis code, and extracting days before departure from the difference between flight date and booking date. Further process follows with identifying relevant features using statistical techniques like Pearson's correlation and regression analysis and combining with an aggregating input from machine learning regression models such as XGBoost, Random Forest, and CatBoost regressors.

In embodiment, the system may utilize a density-based clustering algorithm to segment and label demand clusters, facilitating a nuanced understanding of market demands. At a granular level, such as the flight route, a classification model may be trained based on these segmented demand clusters Density-based clustering algorithms like mean shift are employed to group data based on peaks in density function of the distribution. The bandwidth parameter is crucial for setting the number of clusters, and the challenge is to set it in a way that meaningful clusters are obtained. Further, in the classification model (205) a classifier, such as an XGBoost Classifier, is trained on the labeled data to assign probability scores to request contexts belonging to each identified cluster.

Furthermore, the pricing system isolates features from the context request, assigns a probability score to each request context belonging to each identified cluster, calculates weighted demand scores based on cluster density, and finally calculates the final price using the price range and demand score.

Furthermore, machine learning models, particularly those utilizing techniques like reinforcement learning, can be trained to predict optimal fare adjustments based on a myriad of variables, including historical booking data, customer behavior, and market demand. This predictive capability can enable airlines to proactively adjust fares in a manner that maximizes revenue while catering to the diverse needs of passengers.

Furthermore, the ML system may correspond to a reinforcement learning system or self-learning system in combination with Thompson Sampling to ensure maximum revenue for the airline provider. The system also supports MLOps based efficient model deployment and training.

This specialized training can enhance the accuracy and relevance of pricing decisions. When determining the optimal ticket price, the system may factor in both a minimum and maximum price range, employing a specific formula to compute an optimized price. This approach offers flexibility in pricing while ensuring competitiveness. Recognizing the dynamic nature of markets, the demand score might be calibrated to accommodate deviations, ensuring that pricing strategies remain adaptive and responsive.

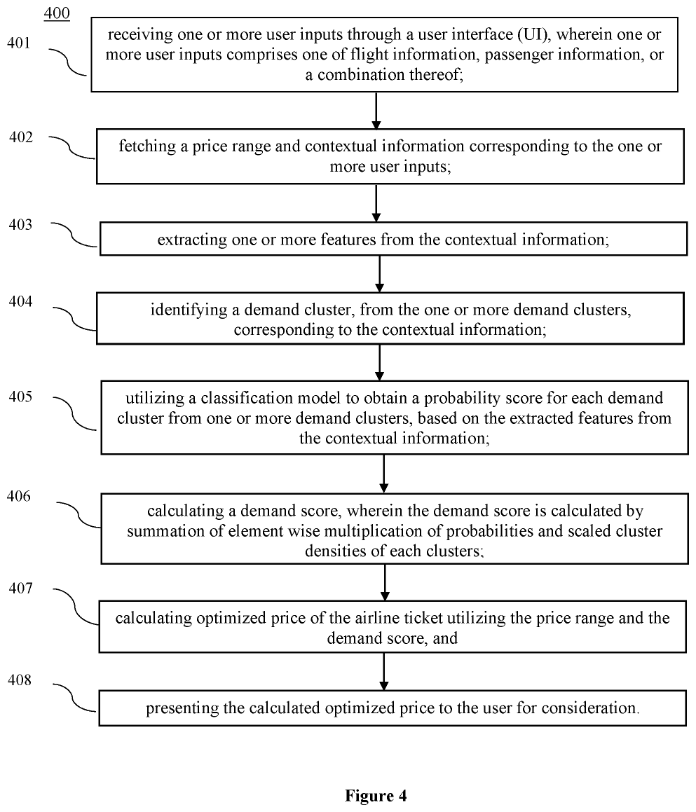

Now referring to FIG. 4, a flowchart describing a method (400) for demand-based optimization of airline ticket pricing, is illustrated in accordance with an embodiment of the present subject matter. The method (400) is structured as a step-by-step process. The method (400) comprises a step for receiving (401) relevant data, including one or more user inputs through a user interface (UI), wherein one or more user inputs comprises one of flight information, passenger information or a combination thereof. Subsequently, the method (400) includes a step of fetching (402) the price range and contextual information corresponding to the one or more user inputs. Furthermore, the method (400) includes a step of extracting (403) one or more features from the contextual information via price optimization module (204). Further, the method (300) comprises a step of identifying (404) a demand cluster, from the one or more demand clusters, corresponding to the contextual information. Furthermore, the method (300) comprises a step of utilizing (405) a classification model (205) to obtain a probability score for each demand cluster from one or more demand clusters, based on the extracted features from the contextual information. The method (300) may further comprise a step of calculating (406) the demand score by summation of element wise multiplication of probabilities and scaled cluster densities of each cluster. Furthermore, the method (300) may further comprise a step of calculating (407) the optimized price of the airline ticket utilizing the price range and the demand score. The method (300) may further comprise a final step of presenting (408) the calculated optimized price to the user for consideration.

In one embodiment, the method (400) may dynamically calculate the optimal ticket price based on demand by receiving user inputs and utilizing machine learning system. This approach may enable airlines to move away from traditional static pricing and consider various criteria, such as time of flight, time of purchase, sales channel, and seat class, to segment passengers beyond the typical business or leisure scenario. The method may also incorporate data-driven capabilities and technology advancements to evolve revenue management strategies. Additionally, the method may involve dropping booking fares into buckets based on the perceived demand, which is determined by the number of seats booked at a certain price, ultimately optimizing the load and the revenue of the flight. Furthermore, the method may leverage model-free reinforcement learning to solve dynamic pricing problems, given the explosion of big data applications, unknown and complex model structures, and high-uncertainty situations. Overall, the method implementation may lead to more sophisticated and creative revenue management strategies for airlines, ultimately improving efficiency and revenue.

It may be noted that the trained data model may be trained using a continuous learning approach like Reinforcement Learning techniques. The trained data model may correspond to data learned by the system to operate efficiently. The trained data model may include iterative datasets that simulate the airline's pricing decisions and their subsequent outcomes, enabling the model to iteratively learn from these scenarios and dynamically adjust its strategies over time. Moreover, the system might integrate reinforcement learning or self-learning mechanisms, possibly combined with strategies like Thompson Sampling. This integration aims to maximize revenue for airlines by continually refining pricing strategies based on evolving data.

In another embodiment, the system may employ sophisticated techniques for feature selection from historical data. By leveraging statistical methodologies like Pearson's correlation or regression analysis, it can discern crucial attributes influencing booking volumes.

In one aspect, an ensemble approach involving combination of statistical methodologies with machine learning regression models like XGBoost, Random Forest, or CatBoost might be utilized to refine feature relevance.

In another embodiment, the system may support efficient model deployment and training based on MLOps principles. Further, by utilizing training data and MLOps practices, machine learning algorithms can be employed to optimize airline ticket pricing based on demand, market conditions, competitor information and other relevant factors, ultimately leading to more efficient revenue management strategies and increased revenue for airlines. This helps in optimizing the deployment and training processes for future iterations.

Overall, this system, incorporating ML, reinforcement learning, and MLOps, addresses the conventional system drawbacks by introducing advanced algorithms for demand-based optimization, adaptive contextual understanding, and efficient data analysis, ultimately revolutionizing the airline ticket pricing paradigm.

### Example

Conventional scenario (Unaided): The conventional system discloses the sudden fare price increase in booking flight.
Route: NYC (JFK)-London (LHR)
Flight date: June 15th
Search criteria: 2 Adults & 2 Children, Length of stay 1 week, weekend included
Pre-filed fares available with the airline:
   Days to departure <3 and weekend included: $800
   Days to departure >3 & <7 and weekend included: $600
   Days to departure >7 & <14 and weekend included: $500
   Days to departure <3 and weekend not included: $900
   Days to departure >3 & <7 and weekend not included: $700
   Days to departure >7 & <14 and weekend not included: $600
For Search date: June 2^{nd}, fare: $500
{Days to departure <14 and weekend included}
For Search date: June 10^{th}, fare: $600
{Days to departure <7 and weekend included}
Using Disclosed System (Aided): The mentioned technology could be used demand-based optimizing of airline ticket pricing.
Route: NYC (JFK)-London (LHR)
Flight date: June 15th
Search criteria: 2 Adults & 2 Children, Length of stay 1 week, weekend included
No pre-filed fares available with the airline, instead a range:
   Min fare: $400
   Max fare: $1000

For Search date: June 2^{nd}, fare: $460
{2 Adults & 2 Children: Inference - family cluster with probability 0.94;
Days to departure: 13 days: Inference - Unplanned travel close to departure date
with probability 0.78
Length of stay 1 week, weekend included: Inference - Leisure cluster with
probability 0.91;
Current demand: 70%, Expected demand: 72%: Inference - Low demand by a
factor of 0.03;
Competitor activity: normal;
Aggregate inference: Family leisure travel during moderate demand and normal
competitor activity - medium to high price sensitivity, moderate opportunity cost
of turning away.
Aggregate demand score (AEQ): 0.10
}
For Search date: June 10^{th}, fare: $580
{2 Adults & 2 Children: Inference - family cluster with probability 0.94;
Days to departure: 5 days: Inference - Unplanned travel close to departure date with
probability 0.88
Length of stay 1 week, weekend included: Inference - Leisure cluster with
probability 0.91;
Current demand: 82%, Expected demand: 85%: Inference - Low demand by a
factor of 0.03;
Competitor activity: normal;
Aggregate inference: Family leisure travel during high demand and normal
competitor activity - medium price sensitivity, moderate opportunity cost of turning
away.
Aggregate demand score (AEQ): 0.30
}

Thus, the disclosed system helps Airlines to maximize revenue by adjusting prices based on demand clusters. Passengers receive personalized fare price range. The system can adapt to market conditions and learn from booking patterns.

The system (100) as disclosed in the disclosure may help in demand-based optimizing of airline ticket pricing in the following advantages:
Improved Revenue Management: The system enables airlines to optimize ticket pricing based on demand, leading to more efficient revenue management and increased profitability.
Enhanced Customer Satisfaction: By dynamically adjusting ticket prices based on demand and avoiding large price jumps from one class to another, the system can offer more competitive and attractive pricing to customers, leading to increased customer experience and likelihood of purchase.
Efficient Resource Utilization: The system's ability to calculate optimized prices based on demand helps in efficient resource allocation, ensuring that flights are well-utilized and revenue is maximized.
Adaptation to Market Trends: By utilizing market data, competitor data and machine learning, the system can adapt pricing strategies in real-time to reflect market conditions, ensuring competitiveness and maximizing revenue.
Improved Decision Making: The system's ability to calculate optimized prices and analyze demand clusters can provide valuable insights for decision making, leading to more informed and effective pricing strategies.

Various modifications to the embodiment will be readily apparent to those skilled in the art and the generic principles herein may be applied to other embodiments. However, one of ordinary skill in the art will readily recognize that the present disclosure is not intended to be limited to the embodiments illustrated but is to be accorded the widest scope consistent with the principles and features described herein.

The foregoing description shall be interpreted as illustrative and not in any limiting sense. A person of ordinary skill in the art would understand that certain modifications could come within the scope of this disclosure.

The embodiments, examples and alternatives of the preceding paragraphs or the description and drawings, including any of their various aspects or respective individual features, may be taken independently or in any combination. Features described in connection with one embodiment are applicable to all embodiments unless such features are incompatible.

1. A system (100) for demand-based optimization of airline ticket pricing, characterized in that, the system (100) comprises:
a processor;
a memory, communicatively coupled with the processor, wherein the memory stores processor-executable instructions, which on execution cause the processor to:
receive one or more user inputs via a user interface (UI) (101), wherein the one or more user inputs comprise one of flight information, passenger information, or a combination thereof;
fetch a price range and contextual information corresponding to the one or more user inputs, wherein the contextual information is dynamically derived from the one or more user inputs, wherein the contextual information comprises origin, destination, flight date, booking date, number of passengers, adult count, child count, flight number, time of flight, days to departure, booking date, category of booking, date context, and destination context;
calculate the optimized price of the airline ticket within the price range by using the contextual information using a machine learning (ML) system, wherein the optimized price is calculated by:
extracting one or more features from the contextual information, wherein the one or more features correspond to relevant features identified based on a combination of a statistical technique with aggregating analysis from a set of machine learning regression models performed on historical data,
utilizing a classification model (205) to obtain a probability score for each demand cluster from one or more demand clusters, based on the one or more extracted features from the contextual information,
identifying a demand cluster, from the one or more demand clusters, corresponding to the contextual information and based on the probability score for each demand cluster,
calculating a demand score, wherein the demand score is calculated by summation of element wise multiplication of probabilities and scaled cluster densities of each clusters,
calculating the optimized price of the airline ticket utilizing the price range and the demand score; and
present the calculated optimized price to the user for consideration.

2. The system (100) as claimed in claim 1, wherein the one or more demand clusters are segmented and labelled using a density-based clustering algorithm.

3. The system (100) as claimed in claim 2, wherein the classification model (205) is trained, at flight route level, based on the labelled one or more demand clusters.

4. The system (100) as claimed in claim 1, wherein the price range comprises a minimum price and a maximum price wherein the optimized price is calculated using a formula: Optimized Price=(minimum price+ (maximum price-minimum price)*demand score).

5. The system (100) as claimed in claim 1, wherein the demand score is finetuned to incorporate deviations in the current market scenario by New Demand Score=Demand Score*(Actual Load Factor/Expected Load Factor).

6. The system (100) as claimed in claim 1, wherein the processor price optimization module (204) is configured to:
perform feature selection from the one or more features of the historical data having significant impact on successful bookings;
evaluate relationships between various attributes and volume of bookings for feature selection by utilizing the statistical technique corresponding to one of Pearson's correlation or regression analysis;
identify the relevant features based on a combination of the statistical technique with aggregating analysis from the set of machine learning regression models selected from one of XGBoost, Random Forest, CatBoost regressors, or a combination thereof.

7. The system (100) as claimed in claim 1, wherein the machine learning system corresponds to reinforcement learning system or self-learning system in combination with Thompson Sampling, to ensure maximum revenue for airline provider.

8. The system (100) as claimed in claim 1, wherein the system (100) ensure revenue increasing of the airline provider by using the demand-based optimization of the airline ticket pricing.

9. The system (100) as claimed in claim 1, wherein the processor is configured to first assess an available fare class corresponding to the flight information on the one or more user inputs, and then fetch the price range corresponding to the available fare class.

10. The system (100) as claimed in claim 1, wherein the UI (101) enables one or more users to search for a flight ticket in response to the one or more user inputs.

11. The system (100) as claimed in claim 1, wherein the system (100) utilizes ML explainability technique to present insights on an AEQ (Airline Experience Quotient) demand scoring in a user-friendly jargon-free explanation of the ML system's calculation of the demand-based optimized airline ticket pricing.

12. The system (100) as claimed in claim 1, wherein the system (100) supports MLOps based automated cluster configuration, model training and efficient model deployment.

13. A method (400) for demand-based optimization of airline ticket pricing, characterized in that, the method (400) comprises:
receiving (401) one or more user inputs through a user interface (UI) (101), wherein the one or more user inputs comprises one of flight information, passenger information, or a combination thereof;
fetching (402), via a processor (201), a price range and contextual information corresponding to the one or more user inputs, wherein the contextual information is dynamically derived from the one or more user inputs, wherein the contextual information comprises origin, destination, flight date, booking date, number of passengers, adult count, child count, flight number, time of flight, days to departure, booking date, category of booking, date context, and destination context;
calculating the optimized price of the airline ticket within the price range by using the contextual information using a machine learning (ML) system, wherein the optimized price is calculated by:
extracting (403), via the processor (201), one or more features from the contextual information, wherein the one or more features correspond to relevant features identified based on a combination of a statistical technique with aggregating analysis from a set of machine learning regression models performed on historical data,
utilizing (405), via the processor (201), a classification model (205) to obtain a probability score for each demand cluster from the one or more demand clusters, based on the one or more extracted features from the contextual information,
identifying (404), via the processor (201), a demand cluster, from one or more demand clusters, corresponding to the contextual information and based on the probability score for each demand cluster,
calculating (406), via the processor (201), a demand score, wherein the demand score is calculated by summation of element wise multiplication of probabilities and scaled cluster densities of each clusters,
calculating (407), via the processor (201), optimized price of the airline ticket utilizing the price range and the demand score; and
presenting (408), via the UI (101), the calculated optimized price to the user for consideration.
